(19) United States
(12) Patent Application Publication
(10) Pub. No.: US 2020/0293147 A1
(43) Pub. Date: Sep. 17, 2020

(54) METHODS AND APPARATUS FOR A CAPACITIVE TOUCH SENSOR

(71) Applicant: SEMICONDUCTOR COMPONENTS INDUSTRIES, LLC, Phoenix, AZ (US)

(72) Inventor: Tetsuya TOKUNAGA, Oura-gun (JP)

(73) Assignee: SEMICONDUCTOR COMPONENTS INDUSTRIES, LLC, Phoenix, AZ (US)

(21) Appl. No.: 16/415,035

(22) Filed: May 17, 2019

Related U.S. Application Data
(60) Provisional application No. 62/819,308, filed on Mar. 15, 2019.

(51) Int. Cl. G06F 3/044; G06F 3/041

(52) U.S. Cl. CPC G06F 3/0445; G06F 2203/04103; G06F 3/0416

(57) ABSTRACT

Various embodiments of the present technology may provide methods and apparatus for a capacitive touch sensor. The capacitive touch sensor may include a first substrate separated from a second substrate by a conducting member. The first substrate may include a first electrode and a second electrode. The conducting member may be in direct contact with the second substrate.

### CROSS-REFERENCE TO RELATED APPLICATION

This application claims the benefit of U.S. Provisional Patent Application Ser. No. 62/819,308, filed on Mar. 15, 2019, and incorporates the disclosure of the application by reference.

### BACKGROUND OF THE TECHNOLOGY

Electronic devices with a touch sensing surface may utilize various capacitive sensing devices to allow a user to make selections and move objects by moving their finger (or stylus) relative to a capacitive sensing element. Mutual capacitance touch sensors not only have the ability to detect touch events on the sensing surface, but also have the ability to detect proximity events, in which the finger is not touching the sensing surface, but is in close proximity to the sensing surface. The mutual capacitive touch sensor operates by measuring the capacitance of the sensor, and detecting a change in capacitance, which indicates a direct touch or presence of a conductive object (e.g., a finger, hand, foot, or other object). When the conductive object comes into contact or close proximity with the capacitive sensor, the capacitance changes and the conductive object is detected. An electrical circuit may be used to measure the change in capacitance and may utilize the change in capacitance to determine the location, pressure, direction, gestures, speed and acceleration of the object as it is approaches, makes contact with, and/or moves across the touch surface of the sensor.

### SUMMARY OF THE INVENTION

Various embodiments of the present technology may provide methods and apparatus for a capacitive touch sensor. The capacitive touch sensor may include a first substrate separated from a second substrate by a conducting member. The first substrate may include a first electrode and a second electrode. The conducting member may be in direct contact with the second substrate.

### BRIEF DESCRIPTION OF THE DRAWINGS

A more complete understanding of the present technology may be derived by referring to the detailed description when considered in connection with the following illustrative figures. In the following figures, like reference numbers refer to similar elements and steps throughout the figures.

FIG. 1 representatively illustrates a side-view of a mutual capacitance touch sensor in accordance with an exemplary embodiment of the present technology;

FIG. 2 representatively illustrates an exploded view of the capacitive touch sensor in accordance with an exemplary embodiment of the present technology;

FIG. 3A representatively illustrates an electric field of the capacitive touch sensor in a first condition and in accordance with an exemplary embodiment of the present technology;

FIG. 3B representatively illustrates an electric field of the capacitive touch sensor in a second condition and in accordance with an exemplary embodiment of the present technology; and

FIG. 4 representatively illustrates a conducting member in accordance with an exemplary embodiment of the present technology;

FIG. 5 representatively illustrates a top view of the conducting member in accordance with a first embodiment of the present technology;

FIG. 6 representatively illustrates a top view of the conducting member in accordance with a second embodiment of the present technology;

FIG. 7 representatively illustrates a top view of the conducting member in accordance with a third embodiment of the present technology;

FIG. 8 representatively illustrates a top view of the conducting member in accordance with a fourth embodiment of the present technology;

FIG. 9 is representatively illustrates a top view of the conducting member in accordance with a fifth embodiment of the present technology;

FIG. 10 representatively illustrates an alternative conducting member in accordance with the present technology;

FIG. 11 representatively illustrates an alternative conducting member in accordance with the present technology;

FIG. 12 representatively illustrates an alternative conducting member in accordance with the present technology; and

FIG. 13 representatively illustrates a side-view of a mutual capacitance touch sensor in accordance with an alternative embodiment of the present technology.

### DETAILED DESCRIPTION OF EXEMPLARY EMBODIMENTS

The present technology may be described in terms of functional block components and circuit diagrams. Such functional blocks and circuit diagrams may be realized by any number of components configured to perform the specified functions and achieve the various results. For example, the present technology may employ various types of analog-to-digital converters, capacitors, amplifiers, power sources, switches, and the like, which may carry out a variety of functions. The methods and apparatus for a capacitive touch sensor according to various aspects of the present technology may operate in conjunction with any electronic device and/or device input application, such as a cellular phone, an audio device, a gaming device, a television, a personal computer, a console, an infotainment center, a control unit, and the like. Furthermore, various aspects of the present technology may be incorporated in any system, such as a vehicle, an appliance, a lighting system, or any other system where capacitive touch sensing is desired.

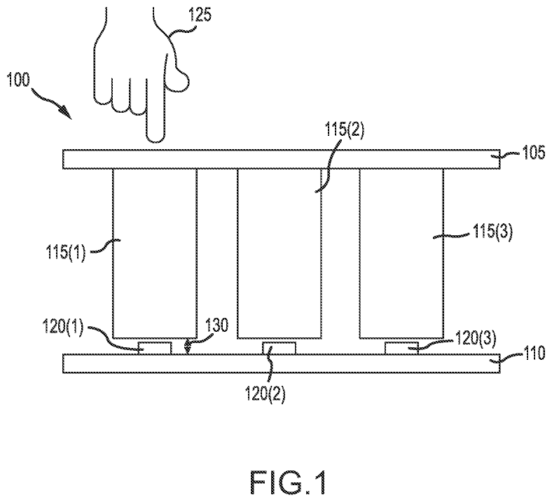

Referring to FIGS. 1-3, and according to the present technology, a touch sensor 100 may be configured as a mutual capacitance sensing to detect an object 125. For example, the touch sensor 100 may comprise a first electrode 200 and a second electrode 205, wherein the first and second electrodes 200, 205 form a capacitance. In addition, the touch sensor 100 may comprise multiple second electrodes arranged to form multiple mutual capacitance-type sensors.

The touch sensor 100 may detect the object 125 by measuring a change in a capacitance between the first electrode 200 and the second electrode 205. The touch sensor 100 may form various input devices, such as buttons, switches, dials, sliders, keys or keypads, navigation pads, touch pad, and may be integrated in any device or system, such a vehicle, an appliance, a lighting system, a control panel, and the like.

The first electrode 200 and the second electrode 205 may form an electric field 300 when a power source (not shown), which may pulse between two voltage levels, provides a drive signal to one of the electrodes. As such, one electrode operates as a drive electrode (i.e., a transmission electrode) and the remaining electrode operates as a reception electrode (i.e., an input electrode). When the object 125, such as a hand, a fingertip, a pen point or like, changes or disrupts the electric field 300, a change in capacitance between the first and second electrodes 200, 205 results. Accordingly, the amount of change in the capacitance may indicate a ‘touch OFF’ condition or a ‘touch ON’ condition.

In various embodiments of the present technology, the touch sensor 100 may be configured to detect the object 125 at a distance by using an indirect touch sensing method. For example, the touch sensor 100 may comprise a first substrate 110, a second substrate 105, and a conducting member 115 situated between the first and second substrates.

The first substrate 110 may provide a stable environment to house various circuitry and elements. For example, the first substrate 110 may comprise the first and second electrodes 200, 205. According to various embodiments, the first substrate 110 may comprise a printed circuit board or any other suitable material.

According to an exemplary embodiment, the touch sensor 100 may comprise a plurality of second electrodes, such as second electrodes 205(1), 205(2), 205(3), nested within the first electrode 200, wherein the first electrode 200 forms a capacitance with each second electrode 205. In other words, each second electrode 205(1), 205(2), 205(3) is in communication with a single first electrode 200. Alternatively, each second electrode 205(1), 205(2), 205(3) may be in communication with a respective first electrode.

According to an exemplary embodiment, the second electrodes 205(1), 205(2), 205(3) may be nested within the first electrode 200. The second electrodes 205(1), 205(2), 205(3) may be separated from the first electrode 200 by a dielectric 210. However, in alternative embodiments, the electrodes 200, 205 may be arranged in any suitable pattern.

In one embodiment, the first substrate 110 may further comprise a light element 120 to illuminate a particular area of the second substrate 105. For example, the light element 120 may comprise an LED (light emitting diode) arranged in a center of the second electrode 205 to indicate (to a user) a location of the most sensitive area of the touch sensor 100.

The second substrate 105 may be arranged parallel to and/or adjacent to the first substrate 110 and configured for direct touching by the object 125. For example, the second substrate 105 may comprise a plastic material. In various embodiments, the second substrate 105 comprises a thin, flexible plastic material capable of being deformed by the object 125. Alternatively, the second substrate 105 may comprise a rigid, plastic material.

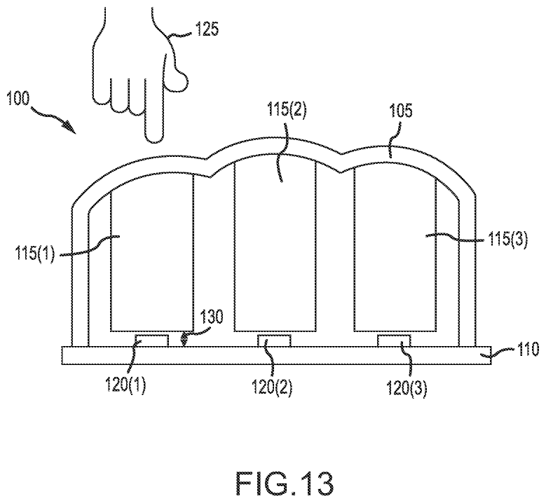

The second substrate 105 may comprise any suitable shape and form. For example, the second substrate 105 may comprise a flat surface that is parallel to the first substrate 110, for example as illustrated in FIG. 1. Alternatively, the second substrate 105 may comprise a surface with one or more protuberances, for example as illustrated in FIG. 13. In addition, the second substrate 105 may comprise bends and/or folds to form a desired shape. The particular shape and form of the second substrate 105 may be selected according to the particular application, desired aesthetics, and the like.

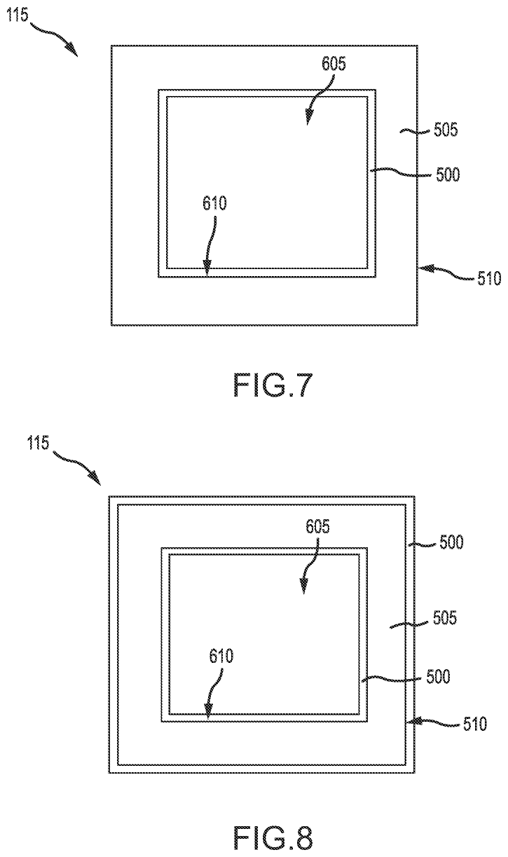

Referring to FIGS. 1-13, the conducting member 115 may be configured to provide indirect touch sensing activation. The conducting member 115 may also serve to guide light emitted from the light element 120 to the second substrate 105. For example, the conducting member 115 may be arranged between the first and second substrates 110, 105 to act as a conduit for the electric field 300 formed by the first and second electrodes 200, 205. In various embodiments, the conducting member 115 is arranged within the electric field 300 formed by the first and second electrodes 200, 205.

According to an exemplary embodiment, a first end 215 of the conducting member 115 may be in direct contact with the second substrate 105. A second end 220 of the conducting member 115 may be separated from the first substrate 110 by an air gap 130. In various embodiments, the air gap 130 may range from 1 to 10 millimeters. Alternatively, the second end 220 of the conducting member 115 may be in direct contact with either the first electrode 200 or the second electrode 205.

According to an exemplary embodiment, the conducting member 115 may comprise a dielectric material 505, such as a plastic material or any other insulting material. The conducting member 115 may comprise any number or combination of dielectric materials. For example, in various embodiments, the conducting member 115 may comprise a single dielectric material. However, in alternative embodiments, the conducting member 115 may comprise multiple dielectric materials, such as a clear/transparent plastic material and an opaque (or colored) plastic material. For example, the conducting member 115 may comprise a clear plastic center extending from the first end 215 to the second end 220 and an opaque plastic surrounding the clear plastic center.

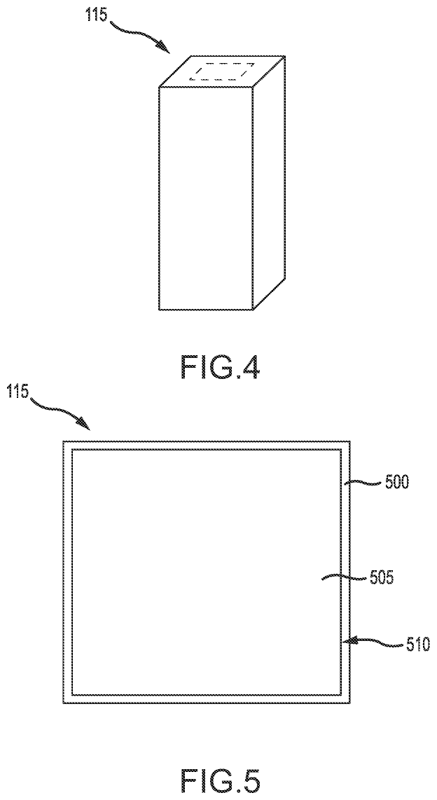

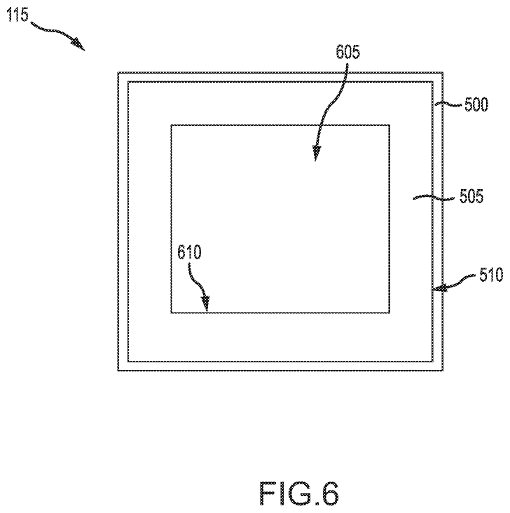

In one embodiment, the conducting member 115 may comprise a single, solid dielectric material 505, such as illustrated in FIG. 5. Alternatively, the conducting member 115 may comprise a hollow interior 605 defined by an interior surface 610 of the dielectric material 505, such as illustrated in FIG. 6. In yet another embodiment, the conducting member 115 may comprise a plurality of sub-members 1100, such as illustrated in FIG. 12.

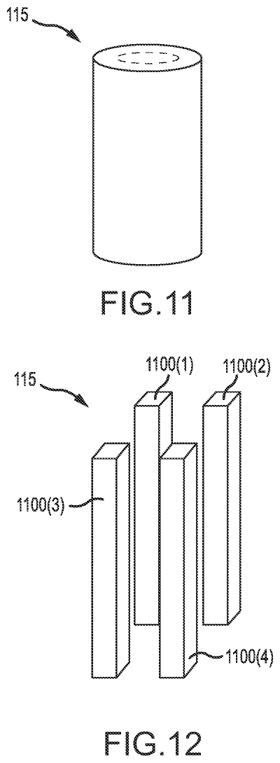

The conducting member 115 and/or the plurality of sub-members 1100 may comprise any suitable shape and size. For example, the dielectric material 505 may be formed in a rectangular or square pillar shape (e.g., as illustrated in FIG. 4), a conical shape (e.g., as illustrated in FIG. 10), a cylinder shape (e.g., as illustrated in FIG. 11), or any other shape.

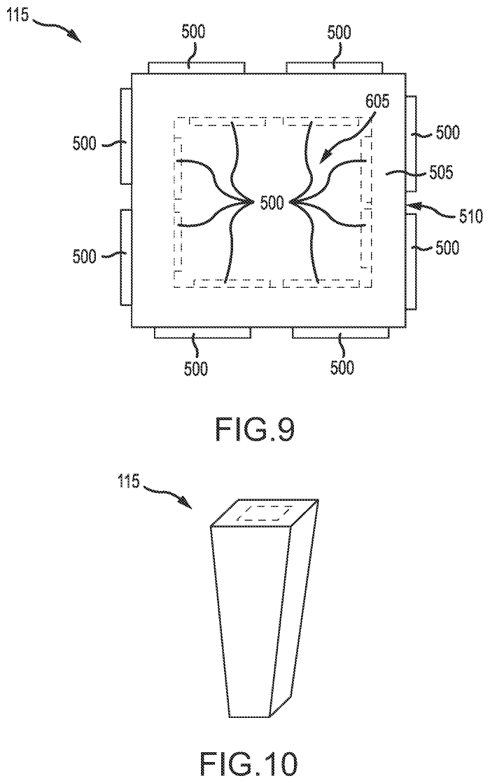

According to an exemplary embodiment, the conducting member 115 may further comprise a conductive material 500, such as a metal material. For example, the conductive material 500 may be formed on an exterior surface 510 of the dielectric material 505 and/or the interior surface 610 of the dielectric material 505. The conductive material 500 may comprise a single, continuous metal coating/plating (e.g., as illustrated in FIGS. 5-8). Alternatively, the conductive material 500 may comprise a plurality of segments of metal coating/plating (e.g., as illustrated in FIG. 9.

In various embodiments, the touch sensor 100 may operate in conjunction with companion circuitry, such as a driver circuit (not shown) and a microprocessor unit (MPU) (not shown). For example, the driver circuit may generate and apply the drive signal to one electrode, such as the first electrode 200. The driver circuit may be connected to and respond to various signals from the MPU. For example, the driver may be connected to the MPU and receive a control signal that controls a voltage of the drive signal. For example, the control signal may indicate a low-voltage (e.g., zero volts) drive signal or a high-voltage (e.g., greater than zero volts) drive signal.

In various embodiments, the microprocessor may be configured to monitor changes in capacitance by receiving an input capacitance from the second electrode 205. The microprocessor may convert the input capacitance to a digital output and compare the digital output to a predetermined threshold to determine if a ‘touch ON’ condition has occurred. Based on the values of the digital output, the microprocessor may determine whether the ‘touch ON’ condition has occurred. For example, the microprocessor may detect when the digital output reaches and/or exceeds the predetermined threshold value according to the change the capacitance. The MPU may respond once the digital output reaches or exceeds the predetermined threshold value. For example, the MPU may transmit a control signal to an output circuit (not shown) to switch states between ON and OFF when the digital output reaches or exceeds the predetermined threshold value, which may indicate the ‘touch ON’ condition.

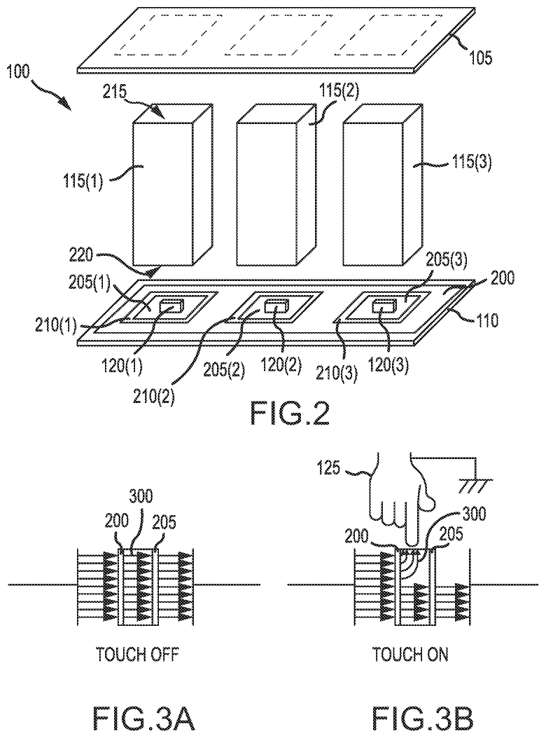

Referring to FIGS. 2 and 3, in accordance with an exemplary embodiment of the present technology, the touch sensor 100 may be configured to operate according to the principles of mutual capacitance sensing described above. In various embodiments, the touch sensor 100 may be configured to detect single inputs, multiple inputs, and gestures, such as rotating, scrolling, flicking, scaling, dragging, and the like.

In operation, and referring to FIGS. 1 and 3A-3B, the touch sensor 100 may detect the object 125 though indirect sensing. For example, the touch sensor 100 detects the object 125 when the object 125 makes direct contact with the second substrate 105. In other words, the object 125 does not make direct contact with the first and second electrodes 200, 205 to create a touch condition. The electric field 300 formed between the first and second electrodes 200, 205 is disturbed when the object 125 touches the second substrate 105 because the object 125 acts as a ground and the conducting member 115 acts as a conduit for a portion of the electric field 300 to be redirected to the object 125. This results in a decrease in the capacitance and the touch sensor 100 transmits a corresponding input signal to the MPU.

The MPU may analyze the input signal to determine if the input signal corresponds to the ‘touch OFF’ condition or the ‘touch ON’ condition. For example, the MPU may determine that a ‘touch ON’ condition has occurred if the change in capacitance is greater than or equal to the predetermined threshold value. In the event of the ‘touch ON’ condition, the touch sensor 100 may act as a switch to turn a device ON or OFF. For example, the touch sensor 100 may operate a light and turn the light ON and OFF. In other applications, in the event of the ‘touch ON’ condition, the MPU may transmit a control signal to a host processor (not shown) to trigger a particular response from the host processor.

The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing description, the technology has been described with reference to specific exemplary embodiments. Various modifications and changes may be made, however, without departing from the scope of the present technology as set forth. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any appropriate order and are not limited to the explicit order presented in the specific examples. Additionally, the components and/or elements recited in any system embodiment may be combined in a variety of permutations to produce substantially the same result as the present technology and are accordingly not limited to the specific configuration recited in the specific examples.

Benefits, other advantages and solutions to problems have been described above with regard to particular embodiments. Any benefit, advantage, solution to problems or any element that may cause any particular benefit, advantage or solution to occur or to become more pronounced, however, is not to be construed as a critical, required or essential feature or component.

The terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to an exemplary embodiment. However, changes and modifications may be made to the exemplary embodiment without departing from the scope of the present technology. These and other changes or modifications are intended to be included within the scope of the present technology.

1. A capacitive touch sensor, comprising:
a first substrate comprising:
a mutual capacitive sensor comprising:
a first electrode; and
a second electrode capable of forming a capacitance with the first electrode;
a second substrate arranged adjacent to the first substrate; and
a conducting member arranged between the first substrate and the second substrate, and comprising a first end, a second end, a dielectric material extending from the first end to the second end, and a conductive material directly adjacent to the dielectric material and extending from the first end to the second end; wherein:
the first end of the conducting member is in direct contact with the second substrate; and
the second end of the conducting member and the first substrate are separated by an air gap.

2. The capacitive touch sensor according to claim 1, wherein the first substrate further comprises a light element.

3. The capacitive touch sensor according to claim 1, wherein the second substrate comprises a plastic material.

4. The capacitive touch sensor according to claim 1, wherein the conductive material is formed on an exterior surface of the dielectric material.

5. The capacitive touch sensor according to claim 1, wherein the dielectric material forms a singular, solid structure.

6. The capacitive touch sensor according to claim 1, wherein the conducting member comprises a hollow interior defined by an interior surface of the dielectric material.

7. The capacitive touch sensor according to claim 6, wherein the conductive material is formed on the interior surface of the dielectric material.

8. The capacitive touch sensor according to claim 1, wherein the conducting member comprises a plurality of sub-members.

9. A capacitive touch sensor, comprising:
a first substrate comprising:
a mutual capacitive sensor comprising:
a first electrode; and
a second electrode capable of forming a capacitance with the first electrode;
wherein the second electrode is surrounded by the first electrode;
a second substrate arranged adjacent to the first substrate; and
a conducting member arranged between the first substrate and the second substrate, and comprising a first end, a second end, a dielectric material extending from the first end to the second end, and a conductive material directly adjacent to the dielectric material and extending from the first end to the second end; wherein:
the first end of the conducting member is in direct contact with the second substrate; and
the second end of the conducting member is in direct contact with one of the first electrode and the second electrode.

10. The capacitive touch sensor according to claim 9, wherein the conducting member comprises a hollow interior defined by an interior surface of the dielectric material, wherein the hollow interior is substantially vertically aligned with the second electrode.

11. The capacitive touch sensor according to claim 10, wherein the conductive material is formed on the interior surface of the dielectric material.

12. The capacitive touch sensor according to claim 9, wherein the dielectric material forms a singular, solid structure and the conductive material is formed on an exterior surface of the dielectric.

13. The capacitive touch sensor according to claim 9, wherein the second substrate comprises a plastic material.

14. The capacitive touch sensor according to claim 9, wherein the dielectric material comprises a plastic material.

15. A capacitive touch sensor, comprising:
a first substrate comprising:
a mutual capacitive sensor comprising:
a first electrode; and
a second electrode capable of forming a capacitance with the first electrode;
wherein the second electrode is positioned on a same plane as the first electrode;
a second substrate arranged adjacent to the first substrate, wherein the second substrate comprises a first plastic material; and
a conducting member, comprising a first end, a second end, a dielectric material extending from the first end to the second end, and a conductive material directly adjacent to the dielectric material and extending from the first end to the second end;
wherein:
the first end is adjacent to the first substrate; and
the second end is in direct contact with the second substrate.

16. The capacitive touch sensor according to claim 15, wherein the conducting member further comprises a hollow interior defined by an interior surface of a second plastic material that extends from the first end of the conducting member to the second end of the conducting member.

17. The capacitive touch sensor according to claim 16, wherein the conductive material is formed on the interior surface of the dielectric material.

18. The capacitive touch sensor according to claim 17, wherein the conductive material is further formed on an exterior surface of the dielectric material.

19. The capacitive touch sensor according to claim 15, wherein the conducting member and the first substrate are separated by an air gap in the range of 1 to 10 millimeters.

20. The capacitive touch sensor according to claim 15, wherein the dielectric material comprises a second plastic material.
